(19) United States
(12) Patent Application Publication
(10) Pub. No.: US 2011/0178941 A1
(43) Pub. Date: Jul. 21, 2011

(54) INTERNET BASED RESUME COLLECTOR AND RELATED METHOD

(76) Inventors: John BALARDO, Bloomfield Hills, MI (US); Stefan WANCZYK, Rochester Hills, MI (US)

(21) Appl. No.: 13/010,493

(22) Filed: Jan. 20, 2011

Related U.S. Application Data
(60) Provisional application No. 61/297,021, filed on Jan. 21, 2010.

(51) Int. Cl. G06Q 10/00; G06F 17/30

(52) U.S. Cl. 705/321; 707/802; 707/769; 707/E17.005; 707/E17.014

(57) ABSTRACT

An internet based resume database collector includes at least one host server. The at least one host server is operative to communicate with the Internet. The resume database system is accessible by a plurality of job candidates and a plurality of employers over the internet. The resume database system includes an interface module, a data collector module and a formatting module. The resume database system further includes a criteria collector module, a search module and a communications module.

### CROSS-REFERENCE TO RELATED APPLICATIONS

This application claims priority to U.S. Provisional Patent Application No. 61/297,021 filed 21 Jan. 2010, which application is herein expressly incorporated by reference.

### FIELD

The present disclosure relates generally to Internet-based database systems and more particularly to an Internet-based resume database system. The present disclosure additionally relates to a method of collecting resumes and searching resumes over the internet.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Internet websites that compile databases of resumes typically allow candidates seeking employment to upload their resumes for a fee. Additionally, these websites may allow employers to subscribe to the databases. The employers may download resumes for a fee and decide whether to interview and/or hire any of the candidates.

Generally, different candidates tend to prepare resumes having different formats. For example, some candidates may list their professional experience in a reverse chronological order while others may not. Additionally, some candidates may customize their resumes by highlighting information that is targeted toward specific prospective employers. Further, a candidate may upload different versions of a resume on different websites. Occasionally, the candidate may revise only some of these versions while leaving others unrevised. Accordingly, some resumes may include information that is stale and/or irrelevant to prospective employers.

Differing formats and content of resumes may impede employers' abilities to effectively search for prospective employees according to preferred criteria. For example, employers may expend considerable amounts of resources on evaluating resumes, conducting preliminary interviews, and so on.

Additionally, subscription charges of these websites may vary. Accordingly, the number of prospective employees and employers subscribing to these websites may vary. Consequently, an employer may need to subscribe to more than one of these websites to find suitable candidates. Similarly, a candidate may need to subscribe to more than one of these websites to find employment.

Further, some of these websites may offer basic service at no cost while offering advanced services for a fee. Based on cost considerations, some subscribers may utilize only the basic services. Employers' search results for candidates and candidates' search results for employers may vary depending on the services utilized. Not using advanced services may result in employers not finding suitable candidates and/or candidates not finding desired employment.

### SUMMARY

According to one particular aspect, the present teachings provide an internet based resume database collection. The internet based resume database collector includes at least one host server. The at least one host server is operative to communicate with the Internet. The resume database system is accessible by a plurality of job candidates and a plurality of employers over the internet. The resume database system includes an interface module, a data collector module and a formatting module. The resume database system further includes a criteria collector module, a search module and a communications module.

According to another aspect, the present teachings relate to a method of collecting resumes from a plurality of job candidates and sharing the resumes with a plurality of prospective employers using an internet based resume database collector. The internet based resume database collector includes at least one host server. The at least one host server is operative to communicate with the Internet. The resume database system is accessible by a plurality of job candidates and a plurality of employers over the internet. The resume database system includes an interface module, a data collector module and a formatting module. The resume database system further includes a criteria collector module, a search module and a communications module.

### BRIEF DESCRIPTION OF DRAWINGS

The present disclosure will become more fully understood from the detailed description and the accompanying drawings, wherein:

FIG. 1 is a functional block diagram of a system comprising a host server that includes a resume database system according to the present disclosure;

FIG. 2 is functional block diagram of the resume database system of FIG. 1; and

FIG. 3 is a functional block diagram of a communication module of the resume database system of FIG. 2.

### DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method may be executed in different order without altering the principles of the present disclosure.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The present disclosure relates to a novel, no-cost resume database system that streamlines formatting and searching of resumes. Additionally, the resume database system provides features to assist prospective employees and employers to effectively communicate with one another. Specifically, the features allow the employers to screen resumes and candidates and find suitable candidates quickly and efficiently.

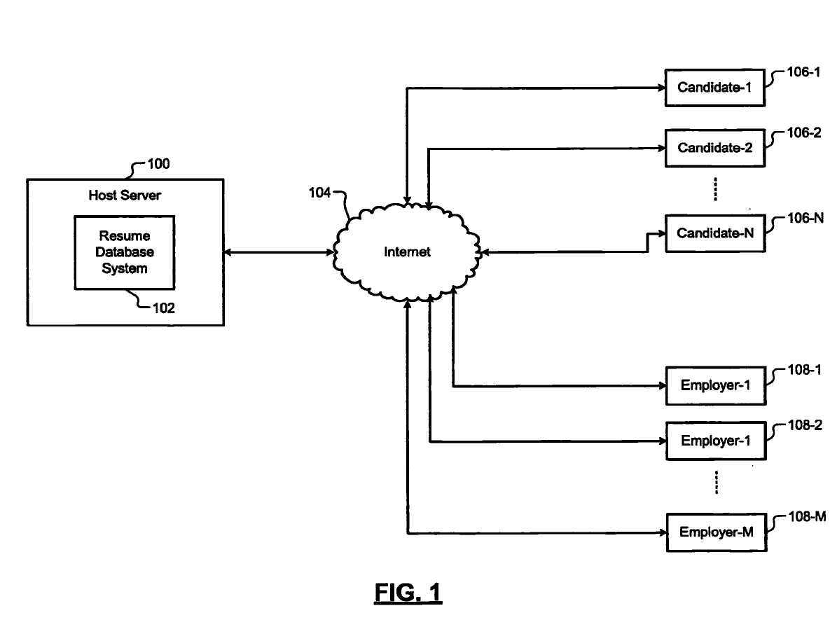

Referring now to FIG. 1, a host server 100 comprising a resume database system 102 according to the present disclosure is shown. The host server 100 communicates with the Internet 104. Although a single host server is shown, a plurality of host servers may be utilized instead. In other words, the resume database system 102 may be implemented across a cluster of host servers that are networked using local and/or wide area network topologies.

Candidate-1 106-1, Candidate-2 106-2, . . . , and Candidate-N 106-N (collectively candidates 106), denote candidates seeking employment. The candidates 106 may access the resume database system 102 via the Internet 104. The candidates 106 may access the Internet 104 using a suitable handheld communication device or a computer.

Employer-1 108-1, Employer-2 108-2, . . . , and Employer-M 108-M (collectively employers 108), denote employers searching for candidates. The employers 108 may access the resume database system 102 via the Internet 104. The employers 108 may access the Internet 104 using a suitable handheld communication device or a computer.

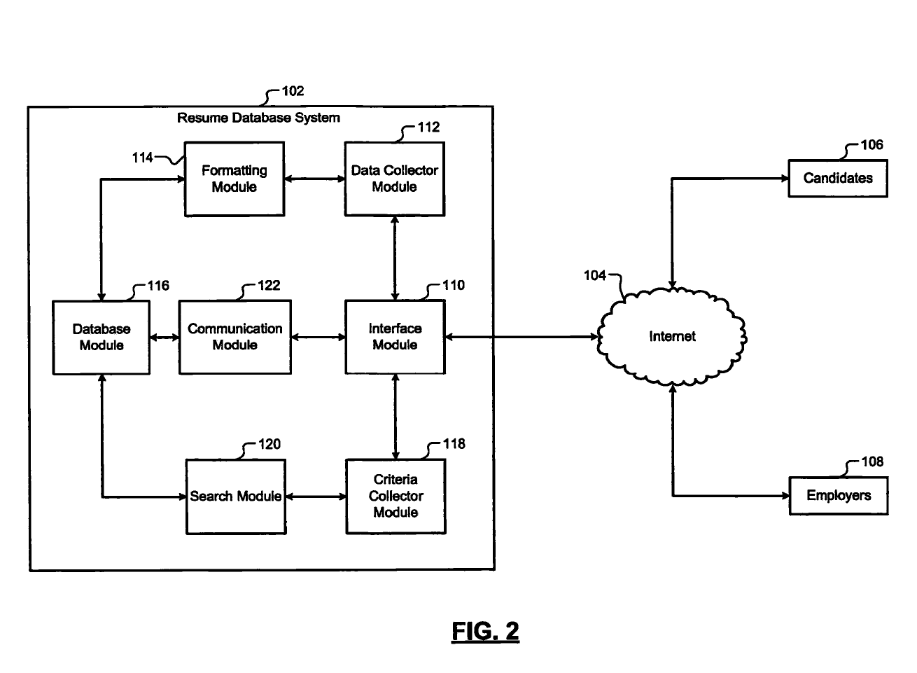

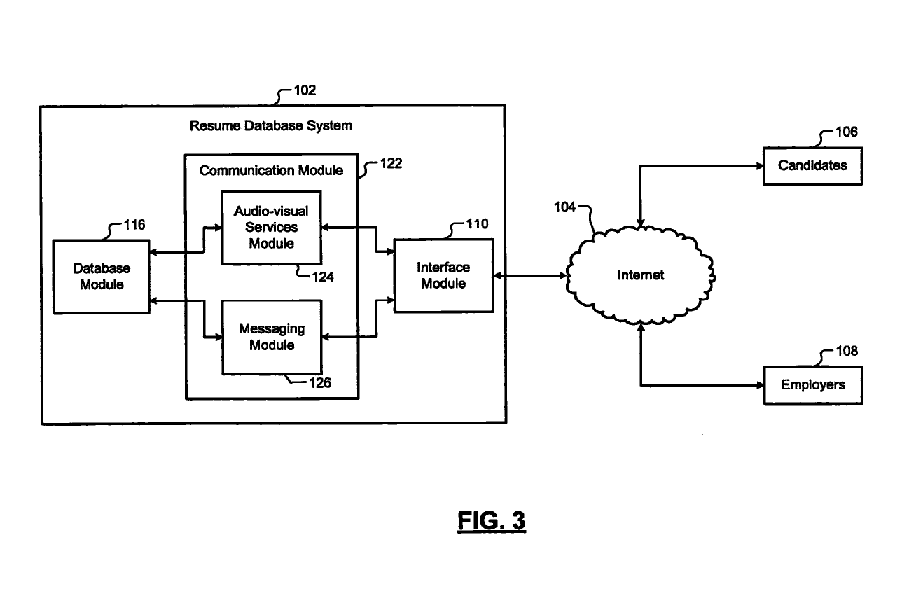

Referring now to FIG. 2, the resume database system 102 comprises an interface module 110, a data collector module 112, a formatting module 114, a database module 116, a criteria collector module 118, and a search module 120. Additionally, the resume database system 102 comprises a communication module 122, which is described with reference to FIG. 3.

The interface module 110 interfaces the resume database system 102 to the Internet 104. The candidates 106 and the employers 108 communicate with the resume database system 102 via the interface module 110. The interface module 110 may control access to the resume database system 102 using one or mode authentication schemes. The authentication schemes may include, but are not limited to, usernames, passwords, and so on. Authorized employers 108 and candidates 106 may access the resume database system 102 free of charge.

The data collector module 112 collects resume data input by the candidates 106. The formatting module 114 formats the resume data and generates formatted resumes. The database module 116 stores the formatted resumes. The criteria collector module 118 receives search criteria (e.g., keywords) from the employers 108 when the employers 108 search for resumes. The search module 120 searches the resumes in the database module 116 based on the search criteria. The search module 120 returns resumes that match the search criteria to the employers 108 via the interface module 110.

Typically, the data collector module 112 may present queries to the candidates 106. The queries may be presented in the form of a suitable graphical user interface (GUI) having drop-down menus. In response, the candidates 106 may input the resume data. In addition to the information that is normally included in typical resumes, the resume data may include other types of digitized data. For example, the resume data may include voice samples, photographs, samples of work products, etc.

Further, the resume data may include information in the form of keywords that can be used by the employers 108 to search the resumes. For example, the keywords may include, but are not limited to, names of universities, number of years of experience, highest educational qualification, and so on.

The formatting module 114 formats the resume data in a format that allows keyword-based search of the formatted resumes. The formatted resumes are stored in the database module 116.

To search the database module 116 for resumes, the criteria collector module 118 presents a simple GUI having drop-down menus to the employers 108. The employers 108 may input search criteria in the form of keywords using the GUI. The criteria collector module 118 collects the keywords input by the employers 108. The search module 120 uses the keywords to search resumes in the database module 116. The search module 120 returns only those resumes that match the search criteria to the employers 108.

For example, an employer seeking a lawyer graduated from Harvard with five years of experience and living in Troy, Mich. can search for resumes using keywords as follows. The employer may enter Profession=Law, School=Harvard, Number of years of experience=5, and Location=Troy, Mich. If the number of resumes found is high, the employer can further refine the search by specifying additional keywords. For example, the employer can select zip code=48098 and radius=5 miles. Alternatively, the employer can further refine the search by specifying a keyword Specialty=Litigator, for example.

In the above example, one of the candidates may have included a redacted appeal brief as a sample of work product in the resume. The employer, however, may not be presently interested in reviewing samples. Accordingly, the employer may not receive the sample with the resume unless the employer searches the resumes using a keyword Samples and selects Samples=Yes, for example.

As another example, an employer seeking a chef with 10 years of experience in cooking Italian food and residing within 25 miles of Detroit may search for resumes using keywords as follows. The employer may enter Profession=Chef, Specialty=Italian, Number of years of experience=10, Location=Detroit, and Radius=25. Some candidates may have included photographs of their signature dishes, copies of awards won at competitions, tasters' reviews, and so on as samples in their resumes. The employer may refine the search for resumes using a keyword Samples=Yes, for example, and receive only those resumes that include samples to narrow the list of the candidates.

Thus, the formatting of the resumes may be independent of types of industry and profession. Accordingly, employers from any industry or profession can quickly and efficiently search for resumes and find candidates with desired skills using the resume database system 102.

Referring now to FIG. 3, the communication module 122 provides multimedia (text, audio, and video) communication services to the employers 108 and the candidates 106. The communication module 122 provides these services via the Internet 104. The employers 108 and the candidates 106 can utilize these services to communicate with each other efficiently.

The communication module 122 comprises an audio-visual (AV) services module 124 and a messaging module 126. The AV services module 124 and the messaging module 126 communicate with the database module 116 and the interface module 110. The AV services module 124 enables the employers 108 to interview the candidates 106 and/or to view AV presentations prepared by the candidates 106. The messaging module 126 allows the employers 108 and the candidates 106 to exchange messages (e.g., emails, references, and so on) securely. Following are examples of some of the functions performed by the AV services module 124 and the messaging module 126.

For example, the employers 108 may request presentations from the candidates 106 whose resumes matched the initial search criteria. The presentations may be on a topic or in response to a questionnaire prepared by the employers 108. Such presentations may be useful in the areas of dramatics, sales and marketing, teaching, public relations, and so on.

Thus, the employers 108 can preview presentation skills of the candidates 106. Such presentations may minimize expenses that would otherwise be incurred if the presentations are conducted in person. Thus, the employers 108 can quickly and efficiently short-list candidates for formal interviews.

The messaging module 126 may allow the employers 108 and the candidates 106 to communicate with each other securely. For example, the parties may exchange emails. The messaging module 126 may protect identities of the parties. For example, the messaging module 126 may translate email IDs of the parties.

Occasionally, the employers 108 may request additional information from the candidates 106. The candidates 106 may provide such information securely using features provided by the messaging module 126. For example, the messaging module 126 may provide security features (e.g., encryption) to protect the information exchanged by the parties.

In addition, the resume database system 102 may host a webpage where the employers 108 can post employment opportunities. The resume database system 102 may allow the candidates 106 to set up alerts when an employer posts a suitable employment opportunity. The candidates 106 may use keywords to set up alerts. For example, the candidates 106 may use key words such as Salary=60,000; Radius=15 miles; and so on.

The search module 120 may use the keyword-based search to identify employment opportunities that match the criteria input by the candidates 106. The messaging module 126 may generate the alerts. The alerts may be delivered to the candidates 106 in a form selected by the candidates 106. For example, the alerts may be delivered to the candidates 106 as instant messages, emails, voice messages, and so on.

Additionally, the resume database system 102 may allow the employers 108 to set up alerts when candidates 106 with desired credentials post resumes. The employers 108 may use keywords to set up alerts. For example, the employers 108 may use key words such as Salary=40,000; Radius=15 miles; and so on.

The search module 120 may use the keyword-based search to identify resumes that match the criteria input by the employers 108. The messaging module 126 may generate the alerts. The alerts may be delivered to the employers 108 in a form selected by the employers 108. For example, the alerts may be delivered to the employers 108 as instant messages, emails, voice messages, and so on.

Throughout the present disclosure, the keyword-based searches are used as examples only. Other types of searches are contemplated. Additionally, email, instant messaging, and so are used for communication as examples only. Other types of communication are contemplated. Further, although not shown, use of hardware and/or software to provide the functionality described is presumed.

The systems and methods described above may be implemented by a computer program executed by one or more processors. The computer program can reside on a tangible computer-readable medium such as but not limited to memory, nonvolatile data storage, and/or other suitable tangible storage mediums.

Further areas of applicability of the present disclosure will become apparent from the detailed description, the claims and the drawings. The detailed description and specific examples are intended for purposes of illustration only and are not intended to limit the scope of the disclosure.

The broad teachings of the disclosure can be implemented in a variety of forms. Therefore, while this disclosure includes particular examples, the true scope of the disclosure should not be so limited since other modifications will become apparent upon a study of the drawings and the specification.

What is claimed is:

1. An internet based resume database collector comprising:
at least one host server including a resume database system, the host server operative to communicate with the Internet, the resume database system accessible by a plurality of job candidates and a plurality of employers over the internet;
the resume database system including:
an interface module;
a data collector module;
a criteria collector module;
a search module; and
a communication module.

2. The internet based resume database collector of claim 2, wherein the at least one host server includes a plurality of host servers networked together.

3. The internet based resume database collector of claim 1, wherein the host server is accessible by a handheld communication device.

4. The internet based resume database collector of claim 4, wherein the interface module interfaces the resume database system to the Internet and the plurality of job candidates and the plurality of employers communicate with the resume database system via the interface module.

5. The internet based resume database collector of claim 1, wherein the data collector module collects resume data input by the plurality of candidates.

6. The internet based resume database collector of claim 5, wherein the formatting module formats the resume data and generates formatted resumes.

7. The internet based resume database collector of claim 1, wherein the criteria collection module receives search criteria from the plurality of employers when one of the employers searches for resumes.

8. The internet based resume database collector of claim 7, wherein the search module searches resumes in the database module based on the search criteria.

9. The internet based resume database collector of claim 8, wherein the search module returns resumes that match the search criteria to the plurality of employers via the interface module.

10. The internet based resume database collector of claim 1, wherein the communications module provides multimedia communications services to the plurality of candidates and the plurality of employers.

11. The internet based resume database collector of claim 10, wherein the communications module provides the multimedia communication services via the internet.

12. The internet based resume database collector of claim 11, wherein the communications module comprises an audio-visual (AV) services module and a messaging module.

13. The internet based resume database collector of claim 12, wherein the AV module services module and the messaging module communicate with the database module and the interface module.

14. A method of collecting resumes from a plurality of job candidates and sharing the resumes with a plurality of prospective database collectors of claim 1.
